(19) United States
(12) Patent Application Publication
(10) Pub. No.: US 2010/0102649 A1
(43) Pub. Date: Apr. 29, 2010

(54) HYDROFORMED COOLING CHANNELS IN STATOR LAMINATIONS

(75) Inventors: Mark John Cherney, Potosi, WI (US); Eric Richard Anderson, Galena, IL (US); Ronald Dean Bremner, Cedar Falls, IA (US)

Correspondence Address: BAKER & DANIELS LLP, 300 NORTH MERIDIAN STREET, SUITE 2700, INDIANAPOLIS, IN, 46204, US

(73) Assignee: Deere & Company, Moline, IL (US)

(21) Appl. No.: 12/262,721

(22) Filed: Oct. 31, 2008

Related U.S. Application Data
(60) Provisional application No. 61/108,300, filed on Oct. 24, 2008.

(51) Int. Cl. H02K 1/20; H02K 15/02

(52) U.S. Cl. 310/54; 29/596

(57) ABSTRACT

A system for cooling an electrical machine is disclosed. The electrical machine includes a rotor, a stator, and at least one cooling tube extending through the stator. During operation of the electrical machine, fluid flows through the tube and carries away heat generated by the electrical machine.

### CROSS REFERENCE TO RELATED APPLICATION

This application claims priority from Provisional Patent Application No. 61/108,300, entitled “Hydroformed Cooling Channels in Stator Laminations,” filed on Oct. 24, 2008 by the same inventors hereof, the disclosure of which is expressly incorporated herein by reference.

### BACKGROUND

1. Field of the Invention

The present disclosure relates to a system for cooling an electrical machine. More particularly, the present disclosure relates to a system for cooling stator laminations of the electrical machine.

2. Description of the Related Art

Electrical machines, including motors and generators, operate by rotating a rotor relative to a stator that surrounds the rotor. Electrical machines generate heat during operation that flows radially outward from the rotor to the stator to an exterior housing. To cool the electrical machine, air or a liquid coolant may be directed through channels located in the exterior housing, through apertures located in sealed laminations of the stator, or through channels located between coils of the stator, for example.

### SUMMARY

The present disclosure provides a system for cooling an electrical machine. The electrical machine includes a rotor, a stator, and at least one cooling tube extending through the stator. During operation of the electrical machine, fluid flows through the tube and carries away heat generated by the machine.

According to an embodiment of the present disclosure, an electrical machine is provided including a rotor and a stator. The stator includes a lamination stack that includes a plurality of laminations aligned coaxially, the lamination stack defining a central bore sized to receive the rotor and at least one cooling bore, at least one tube extending through the at least one cooling bore of the lamination stack, and a cooling fluid positioned in the at least one tube.

According to another embodiment of the present disclosure, an electrical machine is provided including a rotor and a stator. The stator includes a lamination stack that includes a plurality of laminations aligned coaxially. Each of the plurality of laminations includes an outer periphery, an inner periphery defining a central aperture, the central apertures of the plurality of laminations being aligned to define a central bore sized to receive the rotor, and at least one surface defining a radial aperture, the radial apertures of the plurality of laminations aligned to define at least one cooling bore. The stator also includes at least one tube extending through the at least one cooling bore of the lamination stack and a cooling fluid positioned in the at least one tube.

According to yet another embodiment of the present disclosure, a method of manufacturing an electrical machine is providing including the steps of providing an electrical machine that includes a rotor and a stator, the stator defining a central bore that is sized to receive the rotor and at least one cooling bore, and inserting at least one tube into the at least one cooling bore of the stator.

### BRIEF DESCRIPTION OF THE DRAWINGS

The above-mentioned and other features of the present disclosure will become more apparent and the present disclosure itself will be better understood by reference to the following description of embodiments of the present disclosure taken in conjunction with the accompanying drawings, wherein:

FIG. 1 is a perspective view of an embodiment of a motor including a rotor and a stator with cooling tubes extending therethrough;

FIG. 2 is a perspective view of the motor of FIG. 1 showing the motor also including a housing;

FIG. 3 is a top plan view of the stator of FIG. 1 shown without the cooling tubes extending therethrough;

FIG. 4 is a view similar to FIG. 3 showing cooling tubes extending between coils of the stator;

FIGS. 5 and 6 are schematic illustrations of an exemplary method of assembling cooling tubes in a stator;

FIGS. 7 and 8 are schematic illustrations of another exemplary method of assembling cooling tubes in a stator; and

FIG. 9 is a schematic illustration of an exemplary method of operating a stator having cooling tubes extending therethrough.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

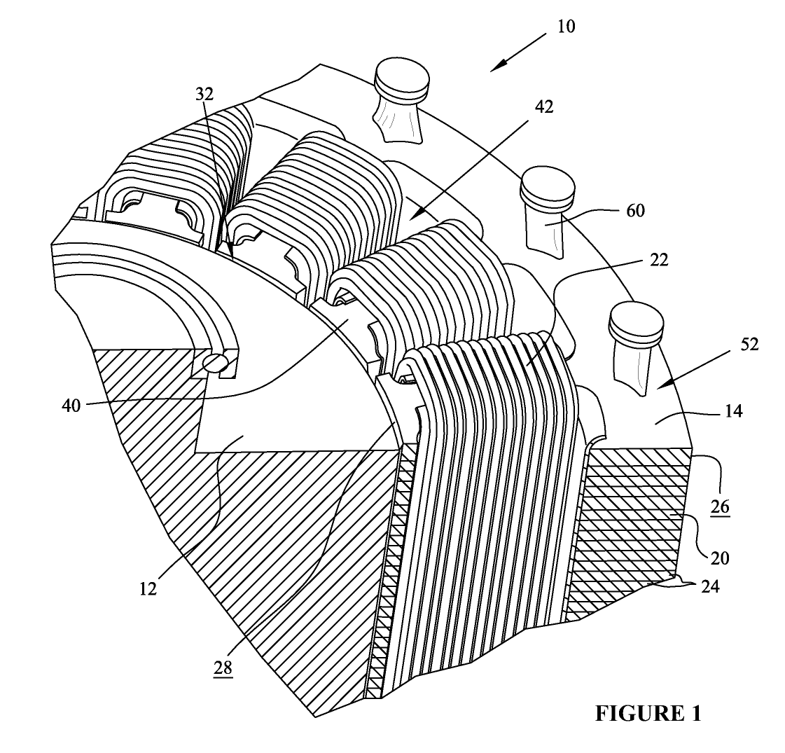

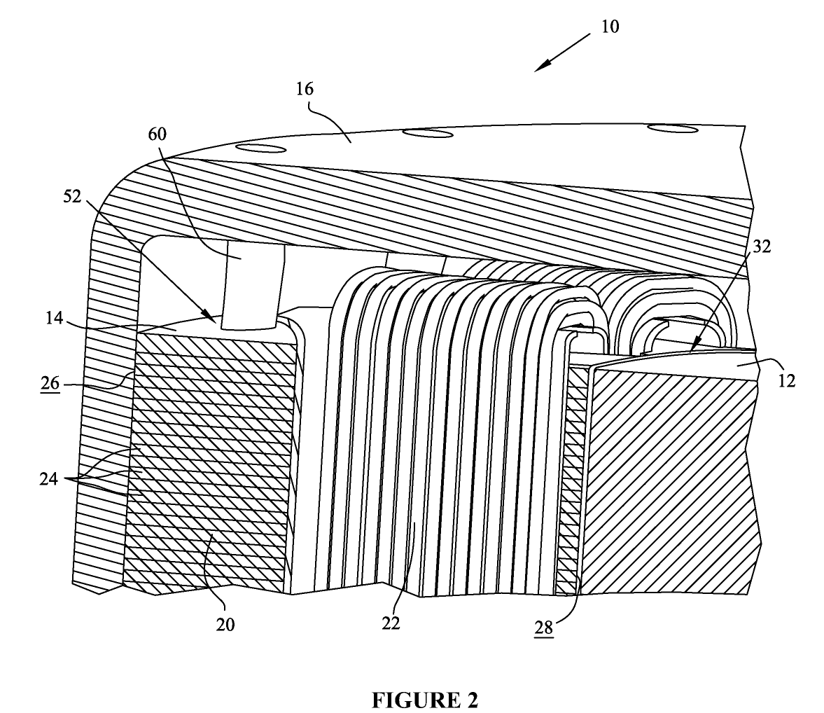

FIG. 1 provides an illustrative electrical machine in the form of motor 10. Although the electrical machine is illustrated and described herein as motor 10, machines of the present disclosure may also include generators, for example. Motor 10 includes rotor 12, stator 14, and, optionally, housing 16 (FIG. 2) surrounding stator 14. In operation, power is supplied to motor 10 to rotate rotor 12 relative to the surrounding stator 14.

Stator 14 includes lamination stack 20 and coils 22. Lamination stack 20 includes a plurality of individual laminations 24 layered and secured together axially. Adjacent laminations 24 may be secured together by welding, with a bonding agent, with a fastening device, or by another suitable technique.

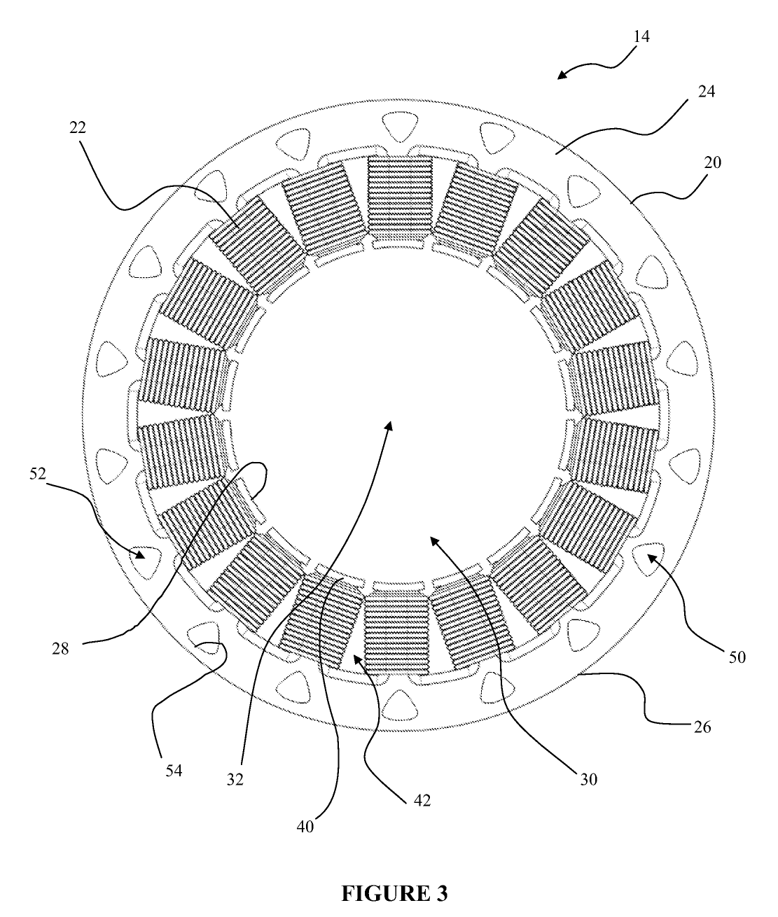

As shown in FIG. 3, each lamination 24 is a disk-shaped body constructed of electrical steel or another suitable ferromagnetic material. Lamination 24 includes an outer periphery 26 and an inner periphery 28 that defines a central aperture 30. When laminations 24 are layered together, adjacent central apertures 30 align to form a central bore 32 that extends axially through lamination stack 20. Central bore 32 is sized to receive rotor 12 (FIG. 1). Inner periphery 28 of lamination 24 also includes a plurality of radially-spaced winding teeth 40. Adjacent winding teeth 40 define winding slots 42 therebetween. When laminations 24 are layered together, wires, such as insulated copper wires, extend through winding slots 42 and wrap around winding teeth 40 to form coils 22. Outer periphery 26 of lamination 24 may include any number of alignment features (not shown), such as indentations, protrusions, and/or markings, to indicate when adjacent laminations 24 are properly aligned.

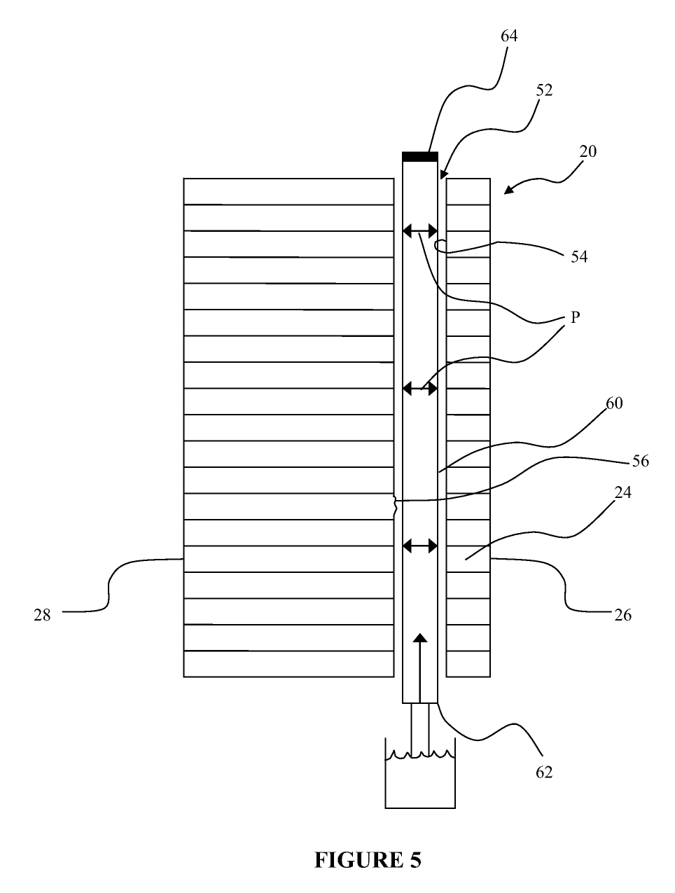

Referring still to FIG. 3, each lamination 24 also includes a plurality of radial apertures 50. Radial apertures 50 are spaced radially across the disk-shaped body of lamination 24. Radial apertures 50 may be formed in lamination 24 by any suitable method. For example, after lamination 24 is stamped from a metal sheet, radial apertures 50 may be formed by cutting or punching holes into the metal sheet. As another example, radial apertures 50 may be formed during a molding process. Radial apertures 50 may be circular, oval, triangular, or another suitable shape. When laminations 24 are layered together, adjacent apertures 50 cooperate to form a plurality of cooling bores 52 that extend through lamination stack 20. In an embodiment, cooling bores 52 extend through lamination stack 20 in a direction essentially parallel to central bore 32. This parallel arrangement may be achieved by aligning adjacent radial apertures 50 directly on top of one another. In another embodiment, cooling bores 52 extend through lamination stack 20 in a helical path around central bore 32. This helical arrangement may be achieved by slightly offsetting adjacent radial apertures 50. In addition to any alignment features (not shown) on outer periphery 26 of lamination 24, apertures 50 themselves may indicate when adjacent laminations 24 are properly aligned. Cooling bores 52 are defined by wall 54 of lamination stack 20. Due to imperfections in the manufacturing of laminations 24 and apertures 50, wall 54 of lamination stack 20 may not be perfectly straight or even. For example, some apertures 50 may be slightly larger than others, so wall 54 may be jagged or uneven. Such an imperfection 56 on wall 54 is shown in FIG. 5. The scale of imperfection 56 may be exaggerated for purposes of illustration.

The number, spacing, shape, and diameter of apertures 50, and thus the number, spacing, shape, and diameter of cooling bores 52, may vary to accomplish adequate cooling of motor 10. For example, a large motor may include more cooling bores 52 than a small motor. As another example, a motor that is run at high speeds and generates a significant amount of heat may include more cooling bores 52 than a motor that is run at lower speeds.

Referring again to FIG. 1, stator 14 of motor 10 includes cooling tubes 60. Cooling tubes 60 extend through lamination stack 20 of stator 14, and specifically through cooling bores 52 in lamination stack 20 of stator 14. Cooling tubes 60 may be constructed of a thermally conductive material, such as copper, a copper alloy, aluminum, or an aluminum alloy, or another suitable material, such as steel or a steel alloy. Each cooling tube 60 includes input end 62 and output end 64, as shown in FIG. 5.

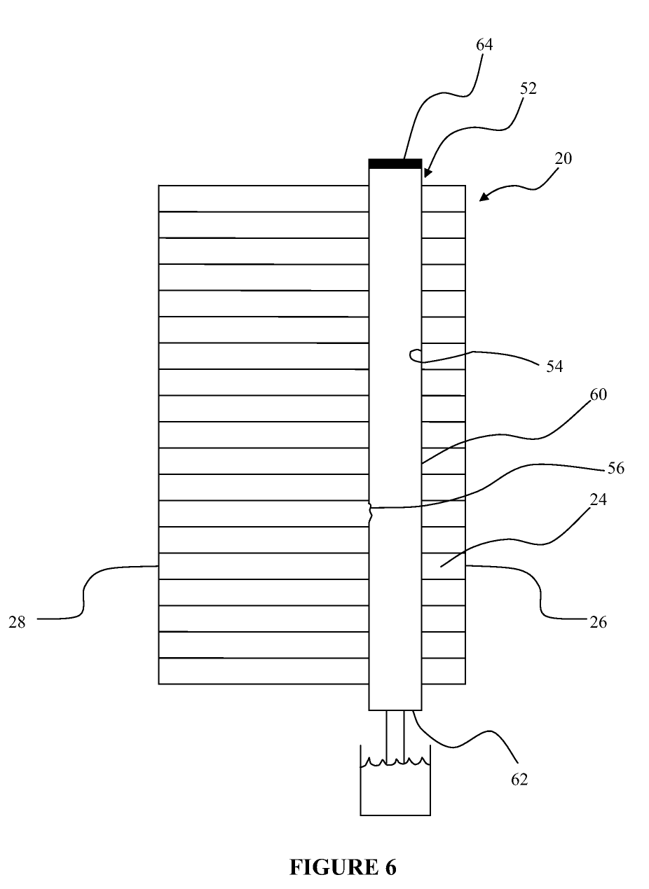

An exemplary method of positioning cooling tubes 60 in lamination stack 20 is illustrated schematically in FIGS. 5 and 6. First, cooling tube 60 is inserted into cooling bore 52 of lamination stack 20. Cooling tube 60 may be a straight, round tube, or cooling tube 60 may have another suitable shape. Next, output end 64 of cooling tube 60 is sealed. After output end 64 is sealed, cooling tube 60 is hydroformed. Specifically, fluid is directed into input end 62 of cooling tube 60 until cooling tube 60 conforms to the shape of cooling bore 52. Initially, pressurized fluid inside cooling tube 60 forces cooling tube 60 to expand outwardly within cooling bore 52, as illustrated schematically in FIG. 5. The pressure applied to cooling tube 60 is indicated by arrows P. The internal pressure should be sufficient to cause the tube material to yield. For example, the internal pressure applied to cooling tube 60 may be slightly greater than atmospheric pressure or as high as approximately 100 psi, 500 psi, 1,000 psi, 5,000 psi, 10,000 psi, or more. The internal pressure may vary depending on, for example, the type of material chosen for cooling tube 60, the thickness of cooling tube 60, and the degree of deformation required of cooling tube 60. As an example, a higher internal pressure would be required to hydroform a tube constructed of steel than would be required to hydroform a tube constructed of a softer material, such as copper or aluminum. As another example, a higher internal pressure would be required to hydroform a thick-walled, rigid tube than would be required to hydroform a thin-walled, pliable tube, such as a tube having a thickness similar to an aluminum soda can. Eventually, the cooling tube 60 contacts wall 54 of lamination stack 20, as illustrated schematically in FIG. 6. Hydroforming cooling tube 60 while it is positioned within cooling bore 52 causes cooling tube 60 to mimic the shape of wall 54, even if wall 54 includes imperfection 56, for example. According to an exemplary embodiment of the present method, a friction fit is achieved between cooling tube 60 and wall 54 of lamination stack 20 surrounding cooling bore 52. An exemplary cooling tube 60 requires a low internal pressure to yield to the shape of cooling bore 52 and also maintains sufficient strength after the hydroforming process.

Cooling tubes 60 may shrink slightly after hydroforming. To ensure that adequate contact is maintained between cooling tubes 60 and walls 54 of lamination stack 20 after hydroforming, lamination stack 20 may be preheated. Heating lamination stack 20 causes cooling bores 52 to expand in diameter. As cooling tubes 60 shrink and begin to pull away from walls 54 of lamination stack 20 after hydroforming, cooling bores 52 also shrink and walls 54 may remain substantially in contact with cooling tubes 60.

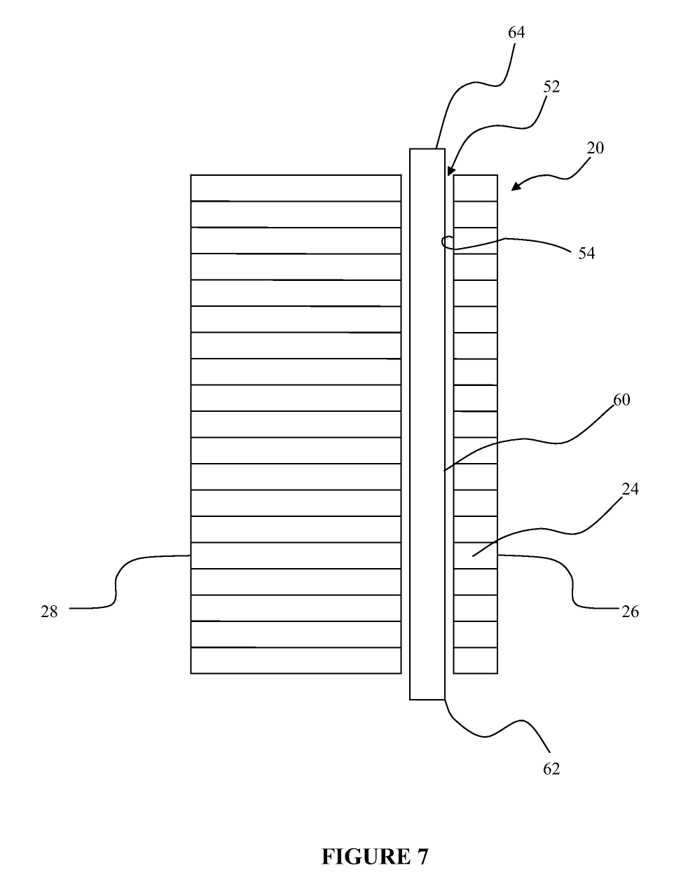

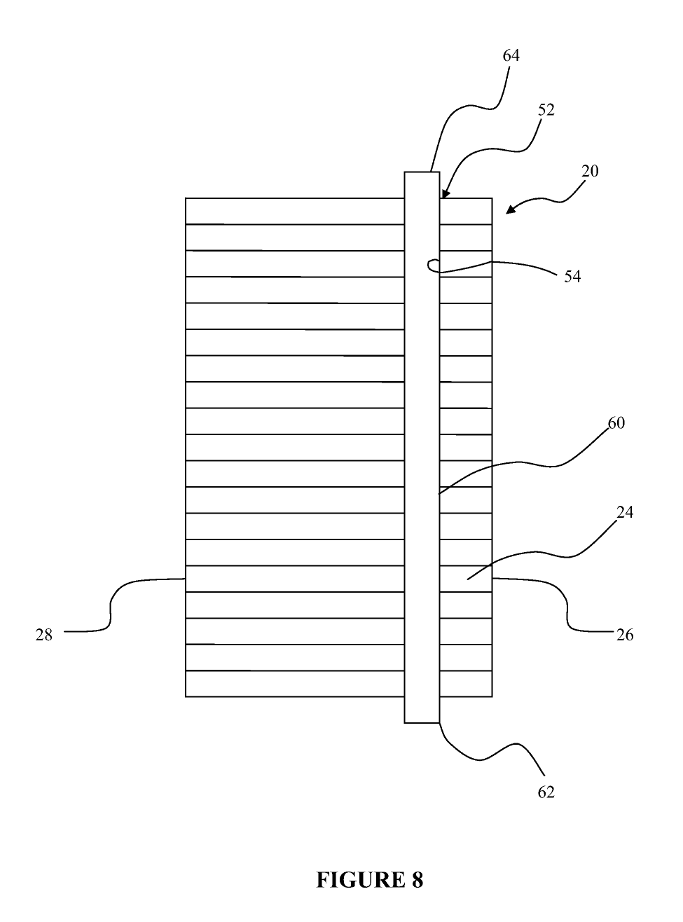

Another exemplary method of positioning cooling tubes 60 in lamination stack 20 is illustrated schematically in FIGS. 7 and 8. First, lamination stack 20 is preheated. Lamination stack 20 need only be heated to a temperature that causes cooling bore 52 to expand to a size that is capable of receiving cooling tube 60 therein. For example, lamination stack may be heated to a temperature of approximately 100° C., 200° C., 300° C., or more. The temperature may vary depending on, for example, the type of material chosen for lamination stack 20, the size of lamination stack 20, the size of cooling bore 52, and the size of cooling tubes 60. According to an exemplary embodiment of the present invention, lamination stack 20 may be heated during an annealing process, and cooling tubes 60 may be inserted following the annealing process to avoid having to reheat lamination stack 20. Next, cooling tube 60 is inserted into cooling bore 52 of the pre-heated lamination stack 20, as shown in FIG. 7. As lamination stack 20 cools, cooling bores 52 shrink and walls 54 contact cooling tubes 60, as shown in FIG. 8. According to an exemplary embodiment of the present method, a friction fit may be achieved between cooling tube 60 and wall 54 of lamination stack 20 surrounding cooling bore 52, with or without hydroforming cooling tube 60.

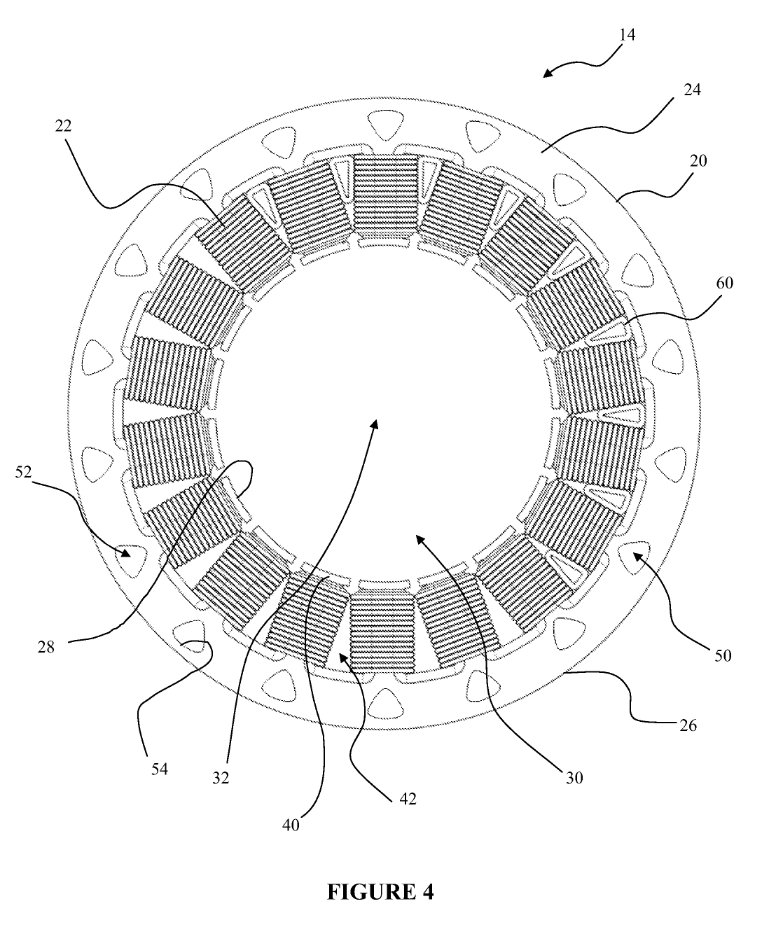

It is also within the scope of the present disclosure that cooling tubes 60 may be positioned between adjacent coils 22 of stator 14, as shown in FIG. 4. In FIG. 4, cooling tubes 60 are shown on a single side of lamination stack 20 for purposes of illustration. However, it is within the scope of the present disclosure that cooling tubes 60 may be placed between all adjacent coils 22 or in an alternating arrangement to surround lamination stack 20, for example. Advantageously, placing cooling tubes 60 between adjacent coils 22 cools the coils 22 directly, rather than indirectly through lamination stack 20. Cooling tubes 60 may be inserted between adjacent coils 22 and hydroformed against coils 22 as described above with respect to cooling bores 52 of lamination stack 20.

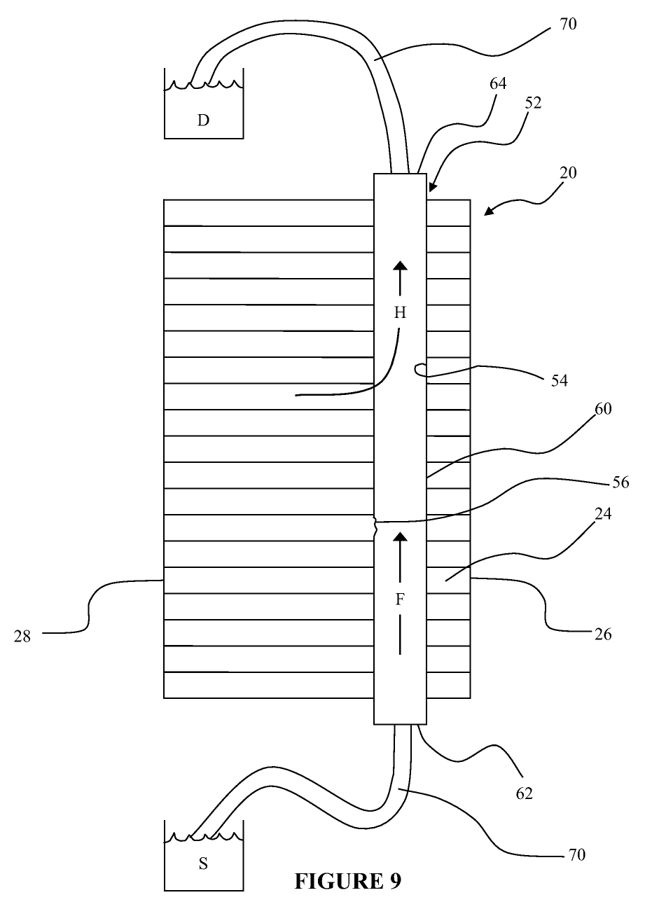

During operation of motor 10, a cooling fluid is directed through cooling tubes 60 to cool motor 10. The cooling fluid may include, for example, oil, water, a mixture of water and ethylene glycol, a mixture of water and propylene glycol, or another suitable heat transfer fluid. Exemplary cooling fluids are capable of removing more heat from motor 10 than air, for example. As illustrated schematically in FIG. 9, the cooling fluid travels from source tank S, into input end 62 of cooling tube 60, through lamination stack 20, out of output end 64 of cooling tube 60, and to destination tank D. The direction of fluid flow is indicated by arrow F. Heat generated by motor 10 is transferred from lamination stack 20, through the walls of cooling tubes 60, and into the cooling fluid flowing therein. The direction of heat flow is indicated by arrow H. According to an exemplary embodiment of the present disclosure, the direct, friction-fit contact between cooling tube 60 and wall 54 of lamination stack 20 that is achieved through hydroforming allows heat to transfer directly from lamination stack 20 to cooling tube 60. The heated fluid that is delivered to destination tank D may be cooled and recycled back to source tank S.

Referring still to FIG. 9, cooling tubes 60 may be coupled to fluid lines 70. Fluid lines 70 may be constructed of flexible rubber tubing, for example. As illustrated schematically in FIG. 4, fluid lines 70 direct the cooling fluid from source tank S to input end 62 of cooling tube 60, and from output end 64 of cooling tube 60 to destination tank D. According to an exemplary embodiment of the present disclosure, fluid lines 70 are coupled to input end 62 and output end 64 of cooling tube 60 in a manner that prevents fluid leakage between the components.

To promote even cooling of lamination stack 20, the cooling fluid may flow in alternating directions through lamination stack 20. For example, the cooling fluid may flow in a first direction through some cooling tubes 60, such as the direction indicated by arrow F in FIG. 9, and in a second direction through other cooling tubes 60, such as a direction opposite arrow F in FIG. 9. This alternating pattern of fluid flow ensures that one side of lamination stack 20 is not cooled to a greater degree than the opposite side of lamination stack 20.

Cooling tubes 60 of the present disclosure may eliminate the need for a sealant that surrounds cooling bores 52. Without cooling tubes 60, lamination stack 20 must be adequately sealed to prevent cooling fluid from leaking between adjacent laminations 24 and toward rotor 12 and coils 22. The sealant may be an ineffective heat conductor, which reduces the heat transfer efficiency of motor 10. Also, the sealant must be allowed to cure or dry, which increases the time required to manufacture motor 10.

Cooling tubes 60 of the present disclosure may also eliminate the need for housing 16 (FIG. 2) of motor 10. Rather than cooling stator 14 indirectly by directing cooling fluid through housing 16, stator 14 may now be cooled directly. Eliminating housing 16 reduces the cost of manufacturing motor 10 and the weight of motor 10.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrical machine including:
a rotor; and
a stator including:
a lamination stack that includes a plurality of laminations aligned coaxially, the lamination stack defining a central bore sized to receive the rotor and at least one cooling bore;
at least one tube extending through the at least one cooling bore of the lamination stack; and
a cooling fluid positioned in the at least one tube.

2. The electrical machine of claim 1, further including a plurality of cooling bores spaced radially about the lamination stack and a plurality of tubes extending therethrough.

3. The electrical machine of claim 1, wherein the central bore extends essentially parallel to the at least one cooling bore.

4. The electrical machine of claim 1, wherein the at least one tube is sized to contact a wall of the lamination stack that surrounds the at least one cooling bore.

5. The electrical machine of claim 1, wherein a wall of the lamination stack that surrounds the at least one cooling bore frictionally engages the at least one tube.

6. The electrical machine of claim 1, wherein the at least one tube is constructed of at least one of copper, a copper alloy, aluminum, an aluminum alloy, steel, and a steel alloy.

7. The electrical machine of claim 1, wherein the stator includes:
a plurality of teeth extending into the central bore of the lamination stack;
a plurality of coils wrapped around the plurality of teeth; and
a second tube extending between adjacent coils.

8. The electrical machine of claim 1, wherein the fluid includes at least one of oil, water, a mixture of water and ethylene glycol, and a mixture of water and propylene glycol.

9. An electrical machine including:
a rotor; and
a stator including:
a lamination stack that includes a plurality of laminations aligned coaxially, each of the plurality of laminations including:
an outer periphery;
an inner periphery defining a central aperture, the central apertures of the plurality of laminations being aligned to define a central bore sized to receive the rotor; and
at least one surface defining a radial aperture, the radial apertures of the plurality of laminations aligned to define at least one cooling bore;
at least one tube extending through the at least one cooling bore of the lamination stack; and
a cooling fluid positioned in the at least one tube.

10. The electrical machine of claim 9, wherein each of the plurality of laminations includes a plurality of surfaces defining radial apertures, the radial apertures are aligned to define a plurality of cooling bores in the lamination stack, and the stator includes a plurality of tubes extending through the plurality of cooling bores.

11. The electrical machine of claim 9, wherein the central bore extends essentially parallel to the at least one cooling bore.

12. The electrical machine of claim 9, wherein the at least one tube is sized to contact the surfaces of the plurality of laminations that define the radial apertures.

13. The electrical machine of claim 9, wherein the surfaces of the plurality of laminations that define the radial apertures frictionally engage the at least one tube.

14. The electrical machine of claim 9, wherein the at least one tube is constructed of at least one of copper, a copper alloy, aluminum, an aluminum alloy, steel, and a steel alloy.

15. The electrical machine of claim 9, further including flexible tubing coupled to a first end and a second end of the at least one tube.

16. The electrical machine of claim 9, wherein the fluid includes at least one of oil, water, a mixture of water and ethylene glycol, and a mixture of water and propylene glycol.

17. A method of manufacturing an electrical machine including the steps of:
providing an electrical machine that includes a rotor and a stator, the stator defining a central bore that is sized to receive the rotor and at least one cooling bore; and
inserting at least one tube into the at least one cooling bore of the stator.

18. The method of claim 17, further including the step of providing a pressurized fluid in the at least one tube to expand the at least one tube against a wall of the stator that defines the at least one cooling bore.

19. The method of claim 18, further including the step of heating the stator prior to providing the pressurized fluid.

20. The method of claim 17, further including the step of hydroforming the at least one tube in the at least one cooling bore of the stator.

21. The method of claim 17, wherein the step of providing the electrical machine includes:
providing a plurality of laminations, each of the plurality of laminations including a radial aperture; and
aligning the radial apertures of the plurality of laminations to form the at least one cooling bore.

22. The method of claim 17, further including the step of coupling flexible tubing to a first end and a second end of the at least one tube.

23. The method of claim 17, further including the step of heating the stator prior to inserting the at least one tube.
